(19) United States
(12) Patent Application Publication
(10) Pub. No.: US 2016/0006370 A1
(43) Pub. Date: Jan. 7, 2016

(54) POWER CONVERSION APPARATUS

(71) Applicant: KABUSHIKI KAISHA YASKAWA DENKI, Kitakyushu-shi (JP)

(72) Inventors: Tomokazu HONDA, Kitakyushu-shi (JP); Akira SASAKI, Kitakyushu-shi (JP); Kiyonori KOGUMA, Kitakyushu-shi (JP); Yoshifumi YAMAGUCHI, Kitakyushu-shi (JP); Yu UJITA, Kitakyushu-shi (JP)

(73) Assignee: KABUSHIKI KAISHA YASKAWA DENKI, Kitakyushu-shi (JP)

(21) Appl. No.: 14/856,562

(22) Filed: Sep. 17, 2015

Related U.S. Application Data
(63) Continuation of application No. PCT/JP2013/058571, filed on Mar. 25, 2013.

(51) Int. Cl. H02M 7/537

(52) U.S. Cl. CPC H02M 7/537

(57) ABSTRACT

A power conversion apparatus includes: a first conductive member; a horizontal switching element disposed on the first conductive member; an insulating member disposed on the first conductive member; and a control switching element disposed on the first conductive member via the insulating member, the control switching element being coupled to the horizontal switching element and configured to control driving of the horizontal switching element.

### CROSS-REFERENCE TO RELATED APPLICATION

The present application is a continuation application of International Application No. PCT/JP2013/058571 filed on Mar. 25, 2013, the entire content of which is hereby incorporated by reference.

### BACKGROUND

1. Technical Field

An embodiment of this disclosure relates to a power conversion apparatus.

2. Description of the Related Art

There has been typically known a power conversion apparatus including a horizontal switching element. Such a power conversion apparatus is disclosed in, for example, JP-A-2011-067051.

The power conversion apparatus disclosed in JP-A-2011-067051 described above includes a GaN field-effect transistor (a horizontal switching element) disposed on the surface of a substrate, and an N-channel MOS transistor (a control switching element). The N-channel MOS transistor is disposed on the surface of the substrate where the GaN field-effect transistor is disposed. The N-channel MOS transistor couples to the GaN field-effect transistor, and controls the driving of the GaN field-effect transistor.

### SUMMARY

A power conversion apparatus includes: a first conductive member; a horizontal switching element disposed on the first conductive member; an insulating member disposed on the first conductive member; and a control switching element disposed on the first conductive member via the insulating member, the control switching element being coupled to the horizontal switching element and configured to control driving of the horizontal switching element.

### BRIEF DESCRIPTION OF THE DRAWINGS

FIG. 1 is a diagram illustrating a circuit of a three-phase inverter device including power modules according to an embodiment;

FIG. 2 is a top view of the power module according to the embodiment;

FIG. 3 is a cross-sectional view taken along the line 200-200 in FIG. 2;

FIG. 4 is a top view of a first substrate of the power module according to the embodiment; and

FIG. 5 is a top view of a second substrate of the power module according to the embodiment.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A power conversion apparatus according to one aspect includes: a first conductive member; a horizontal switching element disposed on the first conductive member; an insulating member disposed on the first conductive member; and a control switching element disposed on the first conductive member via the insulating member, the control switching element being coupled to the horizontal switching element and configured to control driving of the horizontal switching element.

In the power conversion apparatus according to one aspect, the control switching element, which controls the driving of the horizontal switching element, is disposed on the first conductive member, where the horizontal switching element is disposed, via the insulating member. Accordingly, the intervention of the insulating member allows restraining the transfer of the heat generated from the horizontal switching element to the control switching element. This allows restraining the reduction in electrical performance of the control switching element. This consequently allows restraining the decline in power conversion function of the power conversion apparatus. Additionally, the horizontal switching element and the control switching element can be reliably insulated by the insulating member. This allows reducing the distance between the horizontal switching element and the control switching element in plan view. This consequently allows shortening the wiring for coupling the horizontal switching element and the control switching element so as to reduce the impedance. Furthermore, the area of the power conversion apparatus in plan view can be downsized.

In the above-described power conversion apparatus, the decline in function of the power conversion apparatus can be restrained.

In the following, an embodiment will be described with reference to the drawings.

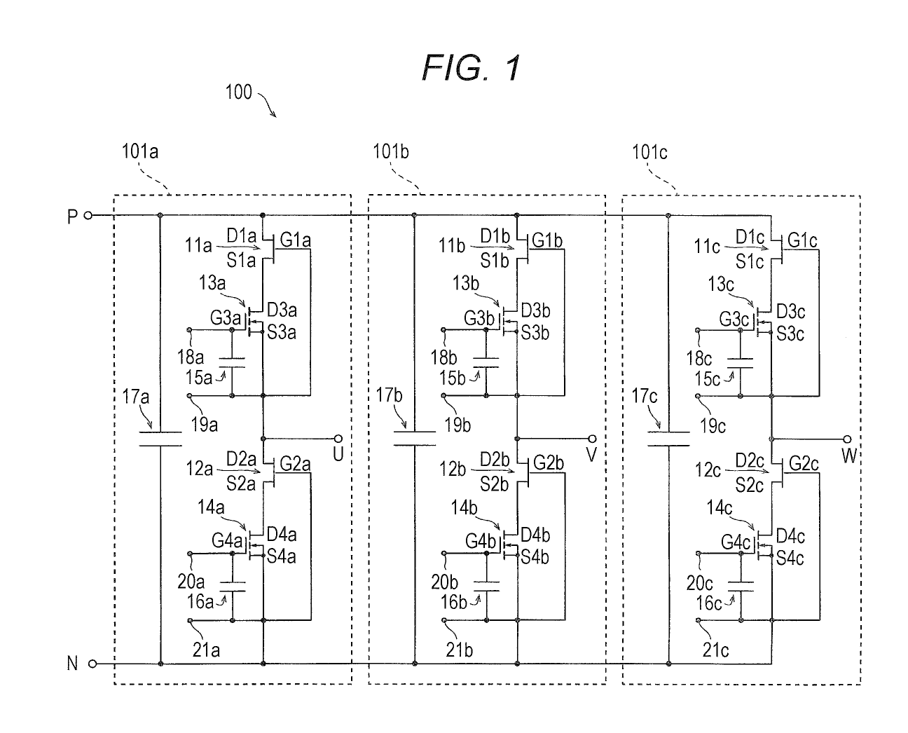

Firstly, a description will be given of the configuration of a three-phase inverter device 100, which includes power modules 101a, 101b, and 101c according to this embodiment, with reference to FIG. 1. The power modules 101a to 101c and the three-phase inverter device 100 are one example of the “power conversion apparatus.”

As illustrated in FIG. 1, the three-phase inverter device 100 includes the three power modules 101a, 101b, and 101c, which electrically coupled in parallel. The respective three power modules 101a, 101 b, and 101c perform power conversions for the U-phase, the V-phase, and the W-phase.

The respective power modules 101a, 101b, and 101c are configured to convert a DC power input from a DC power supply (not illustrated) via input terminals P and N into three-phase (U-phase, V-phase, and W-phase) AC power. The respective power modules 101a, 101 b, and 101c are configured to output the respective U-phase, V-phase, and W-phase AC powers converted as described above to the outside via output terminals U, V, and W. Here, the output terminals U, V, and W couple to a motor (not illustrated) or the like.

The power module 101a includes: two horizontal switching elements 11a and 12a; two control switching elements 13a and 14a, which respectively couple to the two horizontal switching elements; two capacitors 15a and 16a; a snubber capacitor 17a; and terminals 18a, 19a, 20a, and 21a. Here, the horizontal switching elements 11a and 12a are both normally-on type switching elements. That is, the horizontal switching elements 11a and 12a are configured such that electric currents flow between a drain electrode D1a and a source electrode S1a and between a drain electrode D2a and a source electrode S2a when the voltages applied to gate electrodes G1a and G2a are 0 V. The control switching elements 13a and 14a are both normally-off type switching elements. That is, the control switching elements 13a and 14a are configured such that electric currents do not flow between a drain electrode D3a and a source electrode S3a and between a drain electrode D4a and a source electrode S4a when the voltages applied to gate electrodes G3a and G4a are 0 V. The respective control switching elements 13a and 14a are cascode-coupled to the horizontal switching elements 11a and 12a.

The gate electrode G1a (G2a) of the horizontal switching element 11a (12a) couples to the source electrode S3a (S4a) of the control switching element 13a (14a). Accordingly, the control switching element 13a (14a) is configured to perform switching based on the control signal input to the gate electrode G3a (G4a), so as to control the driving (switching) of the horizontal switching element 11a (12a). As a result, the switching circuit including the normally-on type horizontal switching element 11a (12a) and the normally-off type control switching element 13a (14a) is configured to be controlled as a normally-off type switching circuit as a whole.

Similarly to the above-described power module 101a, the power module 101b also includes: two normally-on type horizontal switching elements 11b and 12b; two normally-off type control switching elements 13b and 14b, which are cascode-coupled to these respective two horizontal switching elements; two capacitors 15b and 16b; a snubber capacitor 17b; and terminals 18b, 19b, 20b, and 21b. The normally-on type horizontal switching element 11b (12b) and the normally-off type control switching element 13b (14b) constitute a normally-off type switching circuit. Here, the control switching element 13b (14b) is configured to perform switching based on the control signal input to a gate electrode G3b (G4b) so as to control switching of the horizontal switching element 11b (12b).

Similarly to the above-described power modules 101a and 101b, the power module 101c also includes: two normally-on type horizontal switching elements 11c and 12c; two normally-off type control switching elements 13c and 14c, which are cascode-coupled to these respective two horizontal switching elements; two capacitors 15c and 16c; a snubber capacitor 17c; and terminals 18c, 19c, 20c, and 21c. The normally-on type horizontal switching element 11c (12c) and the normally-off type control switching element 13c (14c) constitute a normally-off type switching circuit. Here, the control switching element 13c (14c) is configured to perform switching based on the control signal input to a gate electrode G3c (G4c) so as to control switching of the horizontal switching element 11c (12c).

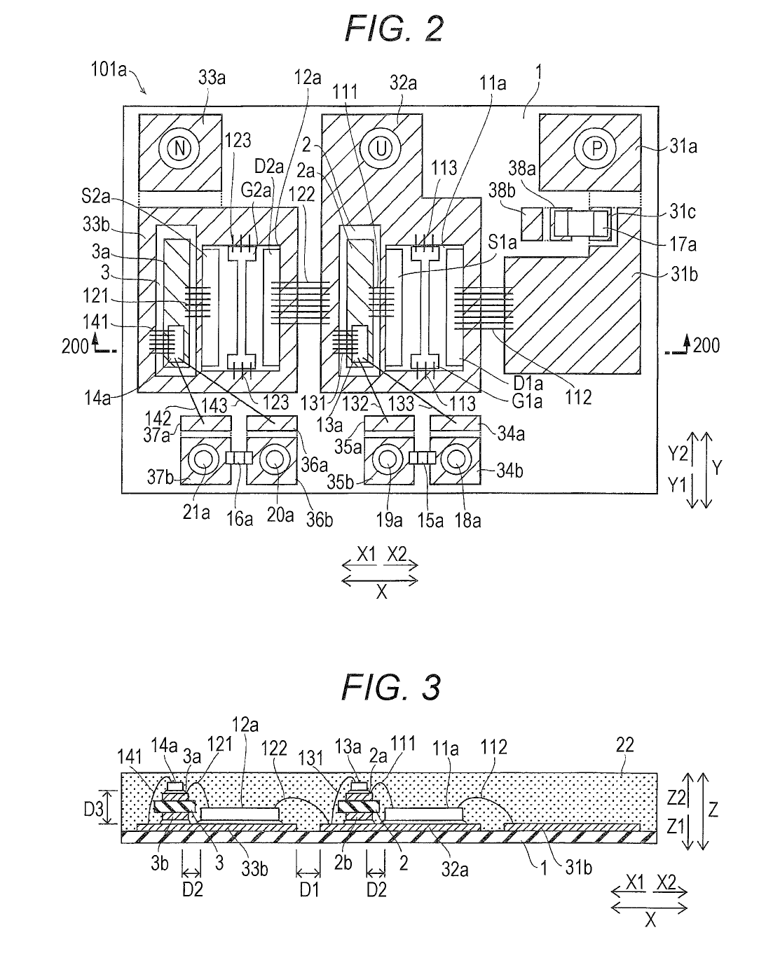

Next, a description will be given of the specific configurations (structures) of the power modules 101a, 101b, and 101c according to this embodiment with reference to FIGS. 2 to 5. Here, the respective power modules 101a, 101b, and 101c have approximately similar configurations. Accordingly, only the power module 101a, which performs power conversion for the U-phase, will be described below.

As illustrated in FIGS. 2 and 3, the power module 101a includes a first substrate 1, two second substrates 2 and 3, the two horizontal switching elements 11a and 12a, the two control switching elements 13a and 14a, the two capacitors 15a and 16a, the snubber capacitor 17a, the terminals 18a, 19a, 20a, and 21a, and sealing resin 22. Here, the second substrates 2 and 3 are one example of an “insulating member.” The second substrate 2 (3) is disposed on a conductive pattern 32a (33b).

As illustrated in FIGS. 2 and 4, conductive patterns 31a, 31b, 31c, 32a, 33a, 33b, 34a, 34b, 35a, 35b, 36a, 36b, 37a, 37b, 38a, and 38b are disposed on the top surface (the upper surface (in the Z2 direction), that is, the surface on the control switching element 13a (14a) side) of the first substrate 1. As illustrated in FIG. 4, solder resist 32b (33c) is disposed in the portion where the second substrate 2 (3) is disposed in the conductive pattern 32a (33b). Each conductive pattern is formed by a metal member such as copper (having a thermal conductivity of about 400 W/mK). Here, the conductive patterns 32a and 33b are examples of a “first conductive member.”

The conductive patterns 31a, 31b and 31c are electrically coupled together inside the first substrate 1. The conductive patterns 33a and 33b are electrically coupled together inside the first substrate 1. The conductive patterns 34a and 34b are electrically coupled together inside the first substrate 1. The conductive patterns 35a and 35b are electrically coupled together inside the first substrate 1.

The conductive patterns 36a and 36b are electrically coupled together inside the first substrate 1. The conductive patterns 37a and 37b are electrically coupled together inside the first substrate 1. The conductive patterns 38a and 38b are electrically coupled together inside the first substrate 1. The conductive pattern 38b and the conductive pattern 33a are electrically coupled together.

As illustrated in FIG. 2, the conductive pattern 31a couples to the input terminal P. The conductive pattern 32a couples to the output terminal U. The conductive pattern 33a couples to the input terminal N.

The conductive pattern 34b couples to the terminal 18a. The conductive pattern 35b couples to the terminal 19a. The conductive pattern 36b couples to the terminal 20a. The conductive pattern 37b couples to the terminal 21a.

As illustrated in FIG. 3, the conductive patterns 32a and 33b are disposed at an interval D1 along the X direction. Accordingly, the conductive patterns 32a and 33b are reliably electrically insulated from each other.

Here, in this embodiment, the second substrate 2 (3) includes an insulating member (for example, ceramics such as Si₃N₄ (having a thermal conductivity of about 25 W/mK)). The insulating second substrate 2 (3) has a thermal conductivity lower than those of the respective conductive patterns of the first substrate 1. As illustrated in FIGS. 2, 3, and 5, a conductive pattern 2a (3a) is disposed on the upper surface (in the Z2 direction) of the second substrate 2 (3). The conductive pattern 2a (3a) is formed by a metal member such as copper.

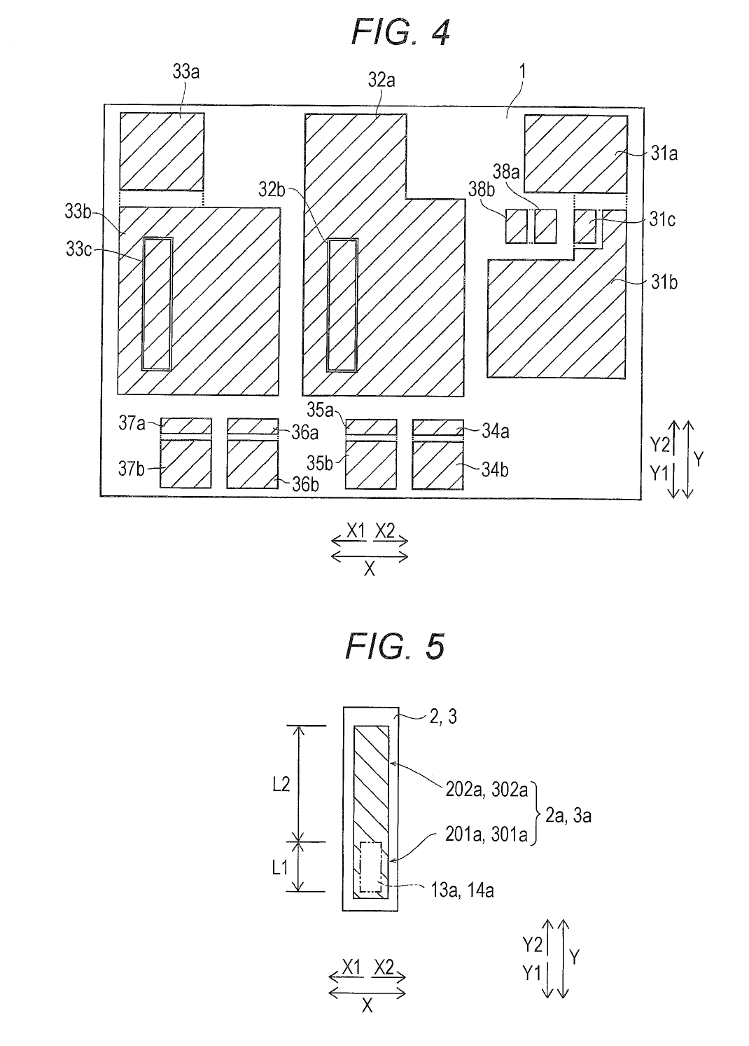

As illustrated in FIG. 2, the conductive pattern 2a (3a) of the second substrate 2 (3) is disposed adjacent to the X direction (the X1 direction) side of the horizontal switching element 11a (12a) in plan view (in a view from the Z direction). As illustrated in FIG. 5, the conductive pattern 2a (3a) includes a first portion 201a (301a) and a second portion 202a (302a). In the first portion 201a (301a), the control switching element 13a (14a) is disposed. The second portion 202a (302a) is adjacent (i.e., disposed adjacent) to the first portion 201a (301a) in plan view. For details, the conductive pattern 2a (3a) is formed to extend in the Y direction (to have the longitudinal direction along the Y direction). In this conductive pattern 2a (3a), the first portion 201a (301a) is disposed on the Y1 direction side, and the second portion 202a (302a) is disposed on the Y2 direction side. In other words, the first portion 201a (301a) and the second portion 202a (302a) are disposed along the Y direction. Here, the X direction is one example of a “first direction.” The Y direction is one example of a “second direction.”

The first portion 201a (301a) has a length of L1 in the Y direction. The second portion 202a (302a) has a length of L2 larger than L1 in the Y direction (the longitudinal direction). That is, the second portion 202a (302a) has an area larger than that of the first portion 201a (301a) in plan view.

As illustrated in FIG. 3, a conductive pattern 2b (3b) is disposed on the lower surface (in the Z1 direction) of the second substrate 2 (3). In the second substrate 2 (3), the conductive pattern 2b (3b) couples to the conductive pattern 32a (33b) of the first substrate 1 via a bonding layer. For details, the conductive pattern 2b (3b) couples to the portion (see FIG. 4) surrounded by the solder resist 32b (33c) in the conductive pattern 32a (33b) of the first substrate 1 via a bonding layer containing solder or the like.

As illustrated in FIG. 2, the horizontal switching element 11a (12a) is disposed on the conductive pattern 32a (33b) of the first substrate 1. The horizontal switching element 11a (12a) is configured such that the gate electrode G1a (G2a), the source electrode S1a (S2a), and the drain electrode D1a (D2a) are all disposed on the surface (the top surface (the surface on the Z2 direction), that is, the surface on the opposite side to the conductive pattern 32a (33b)) on the identical side. That is, when the horizontal switching element 11a (12a) is driven, electric current mainly flows on one surface side, where the respective electrodes are disposed, in the horizontal switching element 11a (12a). Accordingly, the horizontal switching element 11a (12a) generates heat mainly from the surface on the side where the respective electrodes are disposed. In other words, in the horizontal switching element 11a (12a), the surface on the side where the respective electrodes are disposed is a heat generating surface.

The horizontal switching element 11a (12a) includes a semiconductor material containing GaN (gallium nitride). The horizontal switching element 11a (12a) has a heat resistance at a temperature of about 200° C.

As illustrated in FIG. 2, in the horizontal switching element 11a (12a), the drain electrode D1a (D2a) is coupled to the conductive pattern 31b (32a) of the first substrate 1 by a plurality of wires 112 (122). In the horizontal switching element 11a (12a), the source electrode S1a (S2a) is coupled to the conductive pattern 2a (3a) of the second substrate 2 (3) by a plurality of wires 111 (121). Specifically, the source electrode S1a (S2a) of the horizontal switching element 11a (12a) and the second portion 202a (302a) of the conductive pattern 2a (3a) are coupled together by the plurality of wires 111 (121) extending in the X direction. Here, the wires 111 and 121 are examples of a “first wire.”

In the horizontal switching element 11a (12a), the gate electrode G1a (G2a) is coupled to the conductive pattern 32a (33b) of the first substrate 1 by a plurality of wires 113 (123). As illustrated in FIG. 3, the surface (the bottom surface) on the opposite side (the Z1 direction side, that is, the conductive pattern 32a (33b) side) to the surface where the electrodes are disposed in the horizontal switching element 11a (12a) couples to the top surface (the surface on the Z2 direction side, that is, the surface on the control switching element 13a (14a) side) of the conductive pattern 32a (33b) of the first substrate 1 via a bonding layer. That is, the horizontal switching element 11a (12a) is bonded to the top surface (the surface on the Z2 direction side) of the conductive pattern 32a (33b) of the first substrate 1 in the state where the heat generating surface is oriented to the upper side (the Z2 direction side).

The bottom surface (the surface on the Z1 direction side) of the horizontal switching element 11a (12a) is disposed at a position at a height of about 100 μm from the surface of the conductive pattern 32a (33b). The top surface (the surface on the Z2 direction side) of the horizontal switching element 11a (12a) is disposed at a position at a height of about 600 μm from the surface of the conductive pattern 32a (33b).

The control switching element 13a (14a) includes a vertical type device that includes the gate electrode G3a (G4a), the source electrode S3a (S4a), and the drain electrode D3a (D4a). Specifically, in the control switching element 13a (14a), the gate electrode G3a (G4a) and the source electrode S3a (S4a) are disposed on the upper (the Z2 direction) side, and the drain electrode D3a (D4a) is disposed on the lower (the Z1 direction) side. The control switching element 13a (14a) includes a semiconductor material containing silicon (Si). The control switching element 13a (14a) has a heat resistance at a temperature of about 150° C.

Here, in this embodiment, as illustrated in FIG. 3, the control switching element 13a (14a) is disposed on the conductive pattern 32a (33b), where the horizontal switching element 11a (12a) is disposed, via the second substrate 2 (3). For details, the control switching element 13a (14a) is disposed on the second substrate 2 (3) via the conductive pattern 2a (3a).

The bottom surface (the surface on the Z1 direction side, that is, the surface on the conductive pattern 32a (33b) side) of the control switching element 13a (14a) is bonded to the top surface (the surface on the Z2 direction side, that is, the surface on the opposite side to the conductive pattern 32a (33b)) of the first portion 201a (301a) of the conductive pattern 2a (3a) via a bonding layer such as solder. That is, the first substrate 1, the conductive pattern 32a (33b), the second substrate 2 (3), and the control switching element 13a (14a) are disposed to be laminated in this order toward the Z2 direction.

As illustrated in FIG. 5, the control switching element 13a (14a) is disposed in the first portion 201a (301a) of the conductive pattern 2a (3a). The first portion 201a (301a) is disposed in the vicinity of the end on the side (the Y1 direction side) of the terminals 18a and 19a (20a and 21a) in the Y direction in the conductive pattern 2a (3a). As illustrated in FIG. 3, the control switching element 13a (14a) is disposed separately from the horizontal switching element 11a (12a) by an interval D2 in the X direction.

As illustrated in FIGS. 2 and 3, in the control switching element 13a (14a), the drain electrode D3a (D4a) couples to the conductive pattern 2a (3a) of the second substrate 2 (3) via a bonding layer containing solder or the like. In the control switching element 13a (14a), the source electrode S3a (S4a) couples to both the conductive patterns 32a and 35a (33b and 37a) of the first substrate 1 via wires 131 and 132 (141 and 142) containing, for example, copper or aluminum.

That is, the source electrode S3a (S4a) of the control switching element 13a (14a) is coupled to the terminal 19a (21a), which is disposed separately from the conductive pattern 2a (3a) on the Y1 direction side of the conductive pattern 2a (3a), by the wire 132 (142). Here, the wires 132 and 142 are examples of a “second wire.”

In the control switching element 13a (14a), the gate electrode G3a (G4a) couples to the conductive pattern 34a (36a) of the first substrate 1 via a wire 133 (143) containing, for example, copper or aluminum. That is, the gate electrode G3a (G4a) of the control switching element 13a (14a) is coupled to the terminal 18a (20a), which is disposed separately from the conductive pattern 2a (3a) on the Y1 direction side of the conductive pattern 2a (3a), by the wire 133 (143). Here, the wires 133 and 143 are examples of the “second wire.”

As illustrated in FIG. 3, the control switching element 13a (14a) is disposed separately from the conductive pattern 32a (33b) by an interval D3 (for example, about 1000 μm) in the height direction (the Z direction). That is, the bottom surface (the surface on the Z1 direction side) of the control switching element 13a (14a) is disposed at a position at a height of about 1000 μm from the surface of the conductive pattern 32a (33b). Accordingly, the bottom surface (the surface on the Z1 direction side) of the control switching element 13a (14a) is disposed at a position higher than that of the bottom surface (the surface on the Z1 direction side at a height of about 100 μm) of the horizontal switching element 11a (12a). The bottom surface (the surface on the Z1 direction side) of the control switching element 13a (14a) is disposed at a position higher than that of the top surface (the surface on the Z2 direction side at a height of about 600 μm) of the horizontal switching element 11a (12a).

The interval D2 between the horizontal switching element 11a (12a) and the control switching element 13a (14a) in plan view (in a view from the Z direction) is smaller than the interval D3 between the conductive pattern 32a (33b) and the control switching element 13a (14a) in the height direction (the Z direction). That is, the horizontal switching element 11a (12a) and the control switching element 13a (14a) are separated in the height direction (the Z direction) so as to be insulated. This allows reducing the distance in the direction (the X direction) between the conductive pattern 32a (33b) and the control switching element 13a (14a) in plan view.

The interval D2 between the horizontal switching element 11a (12a) and the control switching element 13a (14a) in plan view (in a view from the Z direction) in the conductive pattern 32a (33b) is smaller than the interval D1 between the conductive patterns 32a and 33b in plan view.

As illustrated in FIG. 2, the capacitors 15a and 16a are disposed to restrain the noise. The capacitors 15a and 16a are constituted by, for example, MOS gate capacitors. The capacitor 15a (16a) is disposed to couple the conductive pattern 34b (36b) to the conductive pattern 35b (37b) in the first substrate 1.

As illustrated in FIG. 2, the snubber capacitor 17a is disposed to couple the conductive pattern 31c to the conductive pattern 38a in the first substrate 1.

The sealing resin 22 is filled on the upper side (the Z2 direction side) of the first substrate 1. That is, the horizontal switching element 11a (12a) and the control switching element 13a (14a) are sealed by the sealing resin 22. The sealing resin 22 has a high heat resistance. The sealing resin 22 contains, for example, epoxy-based resin. The sealing resin 22 also contains an insulating material.

In this embodiment, as described above, the control switching element 13a (14a), which controls the driving of the horizontal switching element 11a (12a), is disposed on the conductive pattern 32a (33b), where the horizontal switching element 11a (12a) is disposed, via the second substrate 2 (3). Accordingly, the intervention of the second substrate 2 (3) allows restraining the transfer of the heat generated from the horizontal switching element 11a (12a) to the control switching element 13a (14a). This allows restraining the reduction in electrical performance of the control switching element 13a (14a). This consequently allows restraining the decline in power conversion function of the power module 101a. Additionally, the second substrate 2 (3) allows reliably insulating the horizontal switching element 11a (12a) and the control switching element 13a (14a). This allows reducing the distance between the horizontal switching element 11a (12a) and the control switching element 13a (14a) in plan view (in a view from the Z direction). This consequently allows shortening the wire 111 (121) for coupling the horizontal switching element 11a (12a) and the control switching element 13a (14a) together, so as to reduce the impedance. Furthermore, the area of the power module 101a in plan view can be downsized.

In this embodiment, as described above, the control switching element 13a (14a) is disposed via the conductive pattern 2a (3a) on the second substrate 2 (3). That is, the conductive pattern 2a (3a) is disposed between the second substrate 2 (3) and the control switching element 13a (14a). This allows the conductive pattern 2a (3a) to facilitate wiring in the control switching element 13a (14a).

In this embodiment, as described above, the conductive pattern 2a (3a) includes the first portion 201a (301a) and the second portion 202a (302a). In the first portion 201a (301a), the control switching element 13a (14a) is disposed. The second portion 202a (302a) is disposed adjacent to the first portion 201a (301a) in plan view (in a view from the Z direction). The second portion 202a (302a) has an area larger than that of the first portion 201a (301a) in plan view (in a view from the Z direction). This allows facilitating the radiation of: the heat generated in the control switching element 13a (14a); and the heat transferred from the horizontal switching element 11a (12a), from the second portion 202a (302a) larger than the first portion 201a (301a).

In this embodiment, as described above, the horizontal switching element 11a (12a) and the second portion 202a (302a) of the conductive pattern 2a (3a) are coupled together by the wire 111 (121). This allows simply cascode-coupling the horizontal switching element 11a (12a) and the control switching element 13a (14a) together using the second portion 202a (302a) and the wire 111 (121).

In this embodiment, as described above, the horizontal switching element 11a (12a) and the second portion 202a (302a) of the conductive pattern 2a (3a) are coupled together by the plurality of wires 111 (121). This allows reducing the impedance by the wiring (the wire 111 (121)) and simply ensuring a desired current capacity.

In this embodiment, as described above, the conductive pattern 2a (3a) is disposed adjacent to the horizontal switching element 11a (12a) in the X direction in plan view (in a view from the Z direction) and disposed to have the longitudinal direction of the conductive pattern 2a (3a) along the Y direction. Furthermore, the first portion 201a (301a) and the second portion 202a (302a) in the conductive pattern 2a (3a) are disposed mutually adjacent in the Y direction. Furthermore, the second portion 202a (302a) of the conductive pattern 2a (3a) and the horizontal switching element 11a (12a) are coupled together by the wire 111 (121) extending in the X direction. Accordingly, the second portion 202a (302a), which couples to the wire 111 (121) extending in the X direction, extends in the Y direction so as to allow restraining the increase in length of the wire 111 (121) when the horizontal switching element 11a (12a) and the control switching element 13a (14a) are cascode-coupled together. This also allows reducing the impedance by the wiring (the wire 111 (121)).

In this embodiment, as described above, the length L2 in the longitudinal direction (the Y direction) of the second portion 202a (302a) of the conductive pattern 2a (3a) is larger than the length L1 in the longitudinal direction (the Y direction) of the first portion 201a (301a). This allows ensuring a high degree of freedom for wiring when the plurality of wires 111 (121) couples to the second portion 202a (302a). Additionally, this allows simply ensuring a larger area of the second portion 202a (302a) than the area of the first portion 201a (301a).

In this embodiment, as described above, the control switching element 13a (14a) is disposed in the first portion 201a (301a) of the conductive pattern 2a (3a). The first portion 201a (301a) is disposed in the vicinity of the end on the side of the terminals 18a and 19a (20a and 21a) in the Y direction in the conductive pattern 2a (3a). Furthermore, the control switching element 13a (14a) are coupled to the terminals 18a and 19a (20a and 21a) by the respective wires 133 and 132 (143 and 142). This allows restraining the increase in length of the distance between: the control switching element 13a (14a); and the terminals 18a and 19a (20a and 21a). As a result, the wires 133 and 132 (143 and 142) can be shortened, so as to reduce the impedance by the wiring (the wires 133 and 132 (143 and 142)).

In this embodiment, as described above, the bottom surface (the surface on the Z1 direction side) of the control switching element 13a (14a) is bonded to the top surface (the surface on the Z2 direction side, that is, the surface on the opposite side to the surface on the conductive pattern 32a (33b) side) of the first portion 201a (301a) of the conductive pattern 2a (3a). This allows simply cascode-coupling the horizontal switching element 11a (12a) and the control switching element 13a (14a) together.

In this embodiment, as described above, the horizontal switching element 11a (12a) includes the source electrode S1a (S2a), the drain electrode D1a (D2a), and the gate electrode G1a (G2a), which are disposed on its top surface side (Z2 direction side). Furthermore, the bottom surface (the surface on the Z1 direction side, that is, the surface on the conductive pattern 32a (33b) side) of the horizontal switching element 11a (12a) is bonded to the top surface (the surface on the Z2 direction side, that is, the surface on the control switching element 13a (14a) side) of the conductive pattern 32a (33b). Accordingly, the surface (the bottom surface) on the opposite side to the heat generating surface (the top surface), where the respective electrodes are disposed, in the horizontal switching element 11a (12a) is bonded to the conductive pattern 32a (33b). This consequently allows restraining the transfer of the heat generated from the horizontal switching element 11a (12a) to the control switching element 13a (14a) via the conductive pattern 32a (33b).

In this embodiment, as described above, the first substrate 1 is disposed while having the top surface (the surface on the Z2 direction side, that is, the surface on the control switching element 13a (14a) side) where the conductive pattern 32a (33b) is disposed. This allows collectively and simply forming, for example, the conductive pattern 32a (33b) and the wiring patterns on the first substrate 1.

In this embodiment, as described above, the first substrate 1, the conductive pattern 32a (33b), the second substrate 2 (3) including the insulating member, and the control switching element 13a (14a) are laminated in this order toward the Z2 direction. This allows simply assembling the power module 101a (the three-phase inverter device 100), which can restrain the decline in power conversion function.

In this embodiment, as described above, the insulating second substrate 2 (3) including the insulating member is configured to have a thermal conductivity lower than that of the conductive pattern 32a (33b). This allows effectively restraining the transfer of the heat generated from the horizontal switching element 11a (12a) to the control switching element 13a (14a) via the conductive pattern 32a (33b).

In this embodiment, as described above, the bottom surface (the surface on the Z1 direction side, that is, the surface on the conductive pattern 32a (33b) side) of the control switching element 13a (14a) is disposed at the position (the Z2 direction side) higher than that of the bottom surface (the surface on the Z1 direction side) of the horizontal switching element 11a (12a). Accordingly, the control switching element 13a (14a) and the horizontal switching element 11a (12a) can be separated in the height direction (the Z direction). This allows separating the control switching element 13a (14a) and the horizontal switching element 11a (12a) in the height direction (the Z direction) so as to more reliably ensure insulation. Furthermore, this allows effectively restraining the transfer of the heat generated from the horizontal switching element 11a (12a) to the control switching element 13a (14a). Additionally, the control switching element 13a (14a) and the horizontal switching element 11a (12a) can be separated in the height direction, so as to correspondingly reduce the distance between the control switching element 13a (14a) and the horizontal switching element 11a (12a) in the adjacency direction (the X direction). This consequently allows reducing the area (plane area) of the power module 101a in plan view.

In this embodiment, as described above, the bottom surface (the surface on the Z1 direction side) of the control switching element 13a (14a) is disposed at the position higher than that of the top surface (the surface on the Z2 direction side, that is, the surface on the opposite side to the surface on the conductive pattern 32a (33b) side) of the horizontal switching element 11a (12a). Accordingly, the control switching element 13a (14a) and the horizontal switching element 11a (12a) are separated more in the height direction (the Z direction).

In this embodiment, as described above, the interval D2 between the horizontal switching element 11a (12a) and the control switching element 13a (14a) in plan view (in a view from the Z direction) is smaller than the interval D3 between the conductive pattern 32a (33b) and the control switching element 13a (14a) in the height direction (the Z direction). In this case, the insulation distance between the horizontal switching element 11a (12a) and the control switching element 13a (14a) can be ensured in the height direction (the Z direction). This allows reducing the distance between the horizontal switching element 11a (12a) and the control switching element 13a (14a) in plan view (in a view from the Z direction). As a result, this allows simply reducing the area (plane area) of the power module 101a in plan view.

In this embodiment, as described above, the interval D2 between the horizontal switching element 11a (12a) and the control switching element 13a (14a) in plan view (in a view from the Z direction) in the conductive pattern 32a (33b) is smaller than the interval D1 between the conductive patterns 32a and 33b (between the adjacent conductive patterns) in plan view. This allows disposing the horizontal switching element 11a (12a) and the control switching element 13a (14a) on the identical conductive pattern 32a (33b) and reducing the distance between the horizontal switching element 11a (12a) and the control switching element 13a (14a) in plan view (in a view from the Z direction). As a result, this allows simply reducing the area of the power module 101a in plan view.

In this embodiment, as described above, the horizontal switching element 11a (12a) and the control switching element 13a (14a) are sealed by the insulating sealing resin 22. This allows restraining the invasion of foreign matters to the horizontal switching element 11a (12a) and the control switching element 13a (14a) and enhancing the reliability of the insulation.

In this embodiment, as described above, the control switching element 13a (14a) is cascode-coupled to the horizontal switching element 11a (12a). This allows simply controlling switching of the horizontal switching element 11a (12a) by switching based on a control signal input to the gate electrode G3a (G4a) of the control switching element 13a (14a).

Therefore, the above-disclosed embodiment is considered as illustrative and not restrictive in all respects. The scope of the disclosure is indicated by the appended claims rather than by the foregoing description of the embodiment. All variations falling within the equivalency range of the appended claims are intended to be embraced therein.

For example, in the above-described embodiment, the three-phase inverter device has been described as one example of the power conversion apparatus. In this respect, the power conversion apparatus according to the embodiment of this disclosure may be a power conversion apparatus other than the three-phase inverter device.

In the above-described embodiment, the normally-on type horizontal switching element is used as one example. Alternatively, in the embodiment of this disclosure, a normally-off type horizontal switching element may be used.

In the above-described embodiment, the horizontal switching element includes the semiconductor material containing GaN (gallium nitride) as one example. In this respect, the horizontal switching element may include a III-V group material other than GaN or a IV group material such as C (diamond).

In the above-described embodiment, as one example, a description has been given of the configuration where the horizontal switching element and the control switching element are separated in plan view. In this respect, the horizontal switching element and the control switching element need not be separated in plan view insofar as the horizontal switching element and the control switching element are appropriately insulated (for example, separated in the height direction). For example, the horizontal switching element and the control switching element may be disposed overlapping with one another in plan view via an insulating member or a space.

In the above-described embodiment, as one example, the bottom surface of the control switching element is disposed at the position higher than that of the top surface of the horizontal switching element. In this respect, the bottom surface of the control switching element only needs to be disposed at least in a position higher than that of the bottom surface of the horizontal switching element.

In the above-described embodiment, as one example of the insulating member, the second substrate is used. In this respect, the insulating member may employ a member other than the substrate. For example, the insulating member may employ, for example, an insulating plate, film, or resin.

In the above-described embodiment, as one example of the insulating member, the second substrate containing the Si₃N₄ ceramic is used. In this respect, the insulating member (the second substrate) may employ a ceramic substrate containing a ceramic material other than Si₃N₄ or an insulating substrate (an insulating member) containing an insulating material other than ceramics.

The power conversion apparatus according to this embodiment may be the following first to twentieth power conversion apparatuses.

A first power conversion apparatus includes: a horizontal switching element (11a to 11c, 12a to 12c) disposed on a first conductive member (32a, 33b); and a control switching element (13a to 13c, 14a to 14c) disposed on the first conductive member via an insulating member (2, 3). The control switching element is coupled to the horizontal switching element and configured to control driving of the horizontal switching element.

In a second power conversion apparatus according to the first power conversion apparatus, the control switching element is disposed on the insulating member via the second conductive member (2a, 3a).

In a third power conversion apparatus according to the second power conversion apparatus, in plan view, the second conductive member includes: a first portion (201a, 301a) where the control switching element is disposed; and a second portion (202a, 302a) disposed adjacent to the first portion. The second portion has an area larger than an area of the first portion in plan view.

In a fourth power conversion apparatus according to the third power conversion apparatus, the horizontal switching element and the second portion of the second conductive member are coupled together by a first wire (111, 121).

In a fifth power conversion apparatus according to the fourth power conversion apparatus, the horizontal switching element and the second portion of the second conductive member are coupled together by a plurality of the first wires.

In a sixth power conversion apparatus according to the fourth or fifth power conversion apparatus, the second conductive member is disposed adjacent to the horizontal switching element in a first direction in plan view and to have a longitudinal direction along a second direction intersecting with the first direction. The first portion and the second portion of the second conductive member are disposed mutually adjacent in the second direction. The second portion of the second conductive member and the horizontal switching element are coupled together by the first wire extending in the first direction.

In a seventh power conversion apparatus according to the sixth power conversion apparatus, the second portion of the second conductive member has a longitudinal length larger than a longitudinal length of the first portion in the second direction.

An eighth power conversion apparatus according to the sixth or seventh power conversion apparatus further includes a terminal (18a to 21a) disposed separately from the second conductive member on the second direction side. The control switching element is disposed in the first portion that is disposed in a vicinity of an end on the terminal side in the second direction in the second conductive member, and coupled to the terminal by a second wire (132, 133, 142, 143).

In a ninth power conversion apparatus according to any one of the third to eighth power conversion apparatuses, a surface on the first conductive member side in the control switching element is bonded to a surface on an opposite side to the first conductive member in the first portion of the second conductive member.

In a tenth power conversion apparatus according to any one of the first to ninth power conversion apparatuses, the horizontal switching element includes an electrode (D1a to D1c, D2a to D2c, G1a to G1c, G2a to G2c, S1a to S1c, S2a to S2c) disposed on a surface on an opposite side to the first conductive member. The surface on the first conductive member side in the horizontal switching element is bonded to a surface on the control switching element side in the first conductive member.

An eleventh power conversion apparatus according to any one of the first to tenth power conversion apparatuses further includes a first substrate having a surface on the control switching element side. The surface includes the first conductive member.

In a twelfth power conversion apparatus according to the eleventh power conversion apparatus, the first substrate, the first conductive member, the insulating member, and the control switching element are laminated in this order.

In a thirteenth power conversion apparatus according to any one of the first to twelfth power conversion apparatuses, the insulating member includes an insulating second substrate (2, 3).

In a fourteenth power conversion apparatus according to the thirteenth power conversion apparatus, the insulating second substrate has a thermal conductivity lower than a thermal conductivity of the first conductive member.

In a fifteenth power conversion apparatus according to any one of the first to fourteenth power conversion apparatuses, the surface on the first conductive member side in the control switching element is disposed at least in a position higher than a position of a surface on the first conductive member side in the horizontal switching element.

In a sixteenth power conversion apparatus according to the fifteenth power conversion apparatus, the surface on the first conductive member side in the control switching element is disposed at a position higher than a position of a surface on an opposite side to the first conductive member in the horizontal switching element.

In a seventeenth power conversion apparatus according to any one of the first to sixteenth power conversion apparatuses, a distance between the horizontal switching element and the control switching element in plan view is smaller than a distance between the first conductive member and the control switching element in a height direction.

In an eighteenth power conversion apparatus according to any one of the first to seventeenth power conversion apparatuses, a plurality of the first conductive members are disposed at intervals of a predetermined distance from one another in plan view. In the plurality of the first conductive members, a distance between the horizontal switching element and the control switching element in plan view is smaller than a distance between the adjacent first conductive members in plan view.

In a nineteenth power conversion apparatus according to any one of the first to eighteenth power conversion apparatuses, the horizontal switching element and the control switching element are sealed by sealing resin (22).

In a twentieth power conversion apparatus according to any one of the first to nineteenth power conversion apparatuses, the control switching element is cascode-coupled to the horizontal switching element.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A power conversion apparatus, comprising:
a first conductive member (32a, 33b);
a horizontal switching element (11a to 11c, 12a to 12c) disposed on the first conductive member;
an insulating member (2, 3) disposed on the first conductive member; and
a control switching element (13a to 13c, 14a to 14c) disposed on the first conductive member via the insulating member, the control switching element being coupled to the horizontal switching element and configured to control driving of the horizontal switching element.

2. The power conversion apparatus according to claim 1, further comprising
a second conductive member (2a, 3a) disposed between the insulating member and the control switching element.

3. The power conversion apparatus according to claim 2, wherein
the second conductive member includes a first portion (201a, 301a) where the control switching element is disposed, and a second portion (202a, 302a) adjacent to the first portion in plan view, and
the second portion has an area larger than an area of the first portion in plan view.

4. The power conversion apparatus according to claim 3, wherein
the horizontal switching element and the second portion of the second conductive member are coupled together by a first wire (111, 121).

5. The power conversion apparatus according to claim 4, wherein
the horizontal switching element and the second portion of the second conductive member are coupled together by a plurality of the first wires.

6. The power conversion apparatus according to claim 4, wherein
the second conductive member is adjacent to the horizontal switching element in a first direction in plan view and disposed to have a longitudinal direction of the second conductive member along a second direction intersecting with the first direction,
the first portion and the second portion of the second conductive member are disposed along the second direction, and
the second portion of the second conductive member and the horizontal switching element are coupled together by the first wire extending in the first direction.

7. The power conversion apparatus according to claim 6, wherein
the second portion of the second conductive member has a longitudinal length larger than a longitudinal length of the first portion.

8. The power conversion apparatus according to claim 6, further comprising
a terminal (18a to 21a) disposed separately from the second conductive member on the second direction side, wherein
the first portion of the second conductive member is disposed in a vicinity of an end on the terminal side in the second direction in the second conductive member, and
the control switching element is disposed in the first portion, and coupled to the terminal by a second wire (132, 133, 142, 143).

9. The power conversion apparatus according to claim 3, wherein
a surface on the first conductive member side in the control switching element is bonded to a surface on an opposite side to a surface on the first conductive member side in the first portion of the second conductive member.

10. The power conversion apparatus according to claim 1, wherein
the horizontal switching element includes an electrode (D1a to D1c, D2a to D2c, G1a to G1c, G2a to G2c, S1a to S1c, S2a to S2c) disposed on a surface on an opposite side to a surface on the first conductive member side in the horizontal switching element, and
the surface on the first conductive member side in the horizontal switching element is bonded to a surface on the control switching element side in the first conductive member.

11. The power conversion apparatus according to claim 1, further comprising
a first substrate (1) having a surface on the control switching element side, the surface being provided with the first conductive member.

12. The power conversion apparatus according to claim 11, wherein
the first substrate, the first conductive member, the insulating member, and the control switching element are stacked in this order.

13. The power conversion apparatus according to claim 1, wherein
the insulating member includes an insulating second substrate (2, 3).

14. The power conversion apparatus according to claim 13, wherein
the insulating second substrate has a thermal conductivity lower than a thermal conductivity of the first conductive member.

15. The power conversion apparatus according to claim 1, wherein
the surface on the first conductive member side in the control switching element is disposed at a position higher than at least a position of a surface on the first conductive member side in the horizontal switching element.

16. The power conversion apparatus according to claim 15, wherein
the surface on the first conductive member side in the control switching element is disposed at a position higher than a position of a surface on an opposite side to the surface on the first conductive member side in the horizontal switching element.

17. The power conversion apparatus according to claim 1, wherein
a distance between the horizontal switching element and the control switching element in plan view is smaller than a distance between the first conductive member and the control switching element in a height direction.

18. The power conversion apparatus according to claim 1, wherein
a plurality of the first conductive members is disposed at predetermined intervals from one another in plan view, and
in the plurality of the first conductive members, a distance between the horizontal switching element and the control switching element in plan view is smaller than a distance between the adjacent first conductive members in plan view.

19. The power conversion apparatus according to claim 1, wherein
the horizontal switching element and the control switching element are sealed by sealing resin (22).

20. The power conversion apparatus according to claim 1, wherein
the control switching element is cascode-coupled to the horizontal switching element.
